(19) United States
(12) Patent Application Publication
(10) Pub. No.: US 2019/0244438 A1
(43) Pub. Date: Aug. 8, 2019

(54) CAR SHARING SETTLEMENT METHOD AND CAR SHARING MANAGEMENT SYSTEM

(71) Applicant: Toyota Jidosha Kabushiki Kaisha, Toyota-shi Aichi-ken (JP)

(72) Inventors: Kazuhiro Umeda, Nisshin-shi Aichi-ken (JP); Takumi Fukunaga, Nisshin-shi Aichi-ken (JP); Makoto Akahane, Nagoya-shi Aichi-ken (JP); Satoshi Usui, Machida-shi Tokyo (JP)

(73) Assignee: Toyota Jidosha Kabushiki Kaisha, Toyota-shi Aichi-ken (JP)

(21) Appl. No.: 16/268,018

(22) Filed: Feb. 5, 2019

(30) Foreign Application Priority Data
Feb. 8, 2018 (JP) 2018-021308

(51) Int. Cl. G07B 15/02; G06Q 20/34; G06Q 30/02

(52) U.S. Cl. CPC G07B 15/02; G06Q 30/0283; G06Q 20/341

(57) ABSTRACT

A car sharing settlement method includes: when a user uses a vehicle of car sharing, reading a balance of electronic money stored in an IC chip of the user using an IC reader-writer, the electronic money being prepaid; acquiring a usage fee of the vehicle by the user from a car sharing management device; when the balance is less than the usage fee, subtracting a prescribed amount equal to or less than the balance from the electronic money of the IC chip using the IC reader-writer; and collecting a difference between the usage fee and the prescribed amount during use or after use of the vehicle by the user.

### CROSS-REFERENCE TO RELATED APPLICATION

This application claims priority to Japanese Patent Application No. 2018-021308 filed on Feb. 8, 2018, incorporated herein by reference in its entirety.

### BACKGROUND

### 1. Technical Field

The disclosure relates to a car sharing settlement method and a car sharing management system.

### 2. Description of Related Art

Conventionally, there is known a car rental system in which a return destination terminal installed at a return destination shop of a vehicle receives the total amount of money using a credit card, a prepaid card, or the like of a user so as to perform settlement processing (see Japanese Unexamined Patent Application Publication No. 2007-334565 (JP 2007-334565 A)).

### SUMMARY

When paying a usage fee of car sharing using prepaid electronic money, there is a possibility that, differently from the case of post-pay electronic money that is settled at a later date using a credit card, the balance of the electronic money is less than the usage fee of the car sharing. Therefore, even when a user of the car sharing wishes payment by the prepaid electronic money, since the balance of the electronic money is insufficient, there are cases where the user cannot pay the usage fee of the car sharing.

Accordingly, the disclosure provides a car sharing settlement method and a car sharing management system that enable payment of a usage fee even when the balance of prepaid electronic money is insufficient.

A car sharing settlement method according to a first aspect of the disclosure includes: when a user uses a vehicle of car sharing, reading a balance of electronic money stored in an IC chip of the user using an IC reader-writer, the electronic money being prepaid; acquiring a usage fee of the vehicle by the user from a car sharing management device; when the balance is less than the usage fee, subtracting a prescribed amount equal to or less than the balance from the electronic money of the IC chip using the IC reader-writer; and collecting a difference between the usage fee and the prescribed amount during use or after use of the vehicle by the user.

In the first aspect, collecting the difference may include subtracting the difference from the electronic money of the IC chip using the IC reader-writer, the electronic money having received payment.

In the first aspect, collecting the difference may include notifying the user of a place where payment to the electronic money of the IC chip is enabled.

The first aspect may include causing the car sharing management device to prohibit use of the car sharing by the user after use of the vehicle until the difference is collected.

In the first aspect, collecting the difference may include collecting the difference by a management device of another service that is used by the user.

A car sharing management system according to a second aspect of the disclosure includes an IC reader-writer and a car sharing management device. The IC reader-writer includes: a reading unit configured to, when a user uses a vehicle of car sharing, read a balance of electronic money stored in an IC chip of the user, the electronic money being prepaid; an acquisition unit configured to acquire a usage fee of the vehicle by the user from the car sharing management device; a subtraction unit configured to, when the balance is less than the usage fee, subtract a prescribed amount equal to or less than the balance from the electronic money of the IC chip; and a collection unit configured to collect a difference between the usage fee and the prescribed amount during use or after use of the vehicle by the user.

According to the disclosure, it is possible to provide a car sharing settlement method and a car sharing management system that enable payment of a usage fee even when the balance of prepaid electronic money is insufficient.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a configuration diagram showing one example of a schematic configuration of a car sharing management system according to an embodiment;

FIG. 2 is a data structure diagram showing one example of a car sharing reservation file shown in FIG. 1;

FIG. 3 is a data structure diagram showing one example of a user table shown in FIG. 1;

FIG. 4 is a flowchart for explaining one example of the operation of the car sharing management system shown in FIG. 1; and

FIG. 5 is a flowchart for explaining another example of the operation of the car sharing management system shown in FIG. 1.

### DETAILED DESCRIPTION

An embodiment of the disclosure will be described below. In the following description of the drawings, the same or like elements are denoted by the same or like symbols. It is to be noted that the drawings are only exemplary. The technical scope of the disclosure should not be interpreted as being limited to the embodiment.

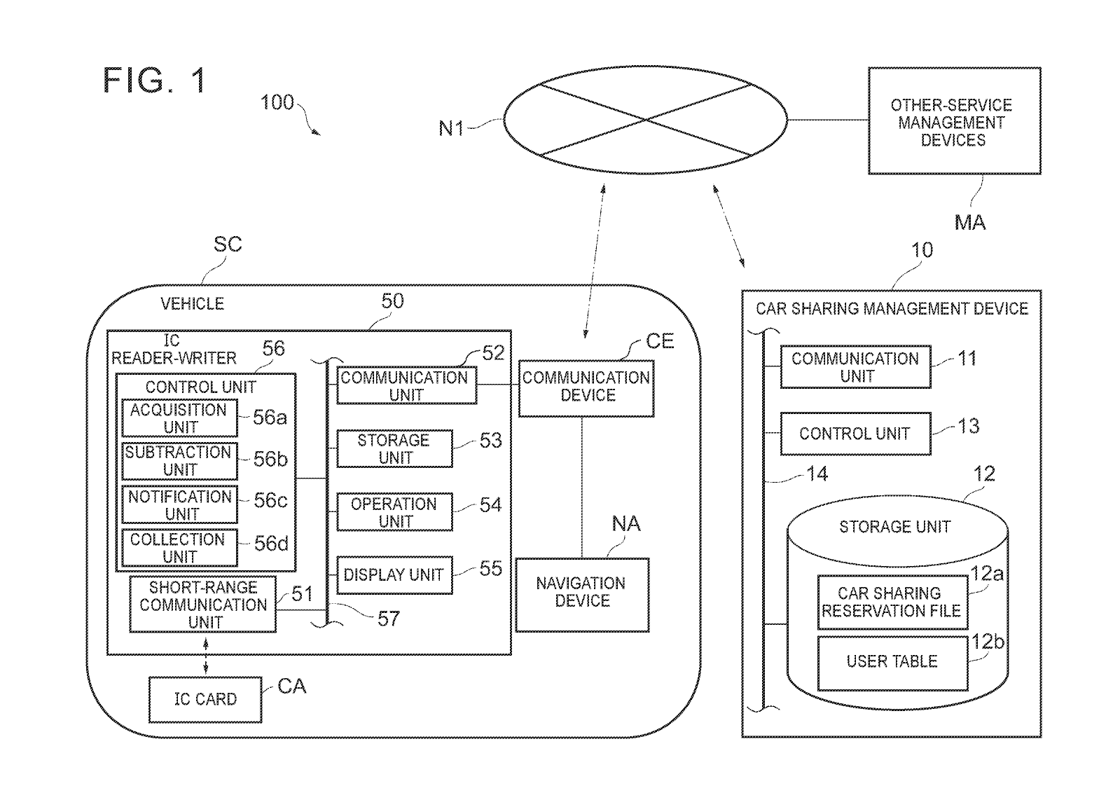

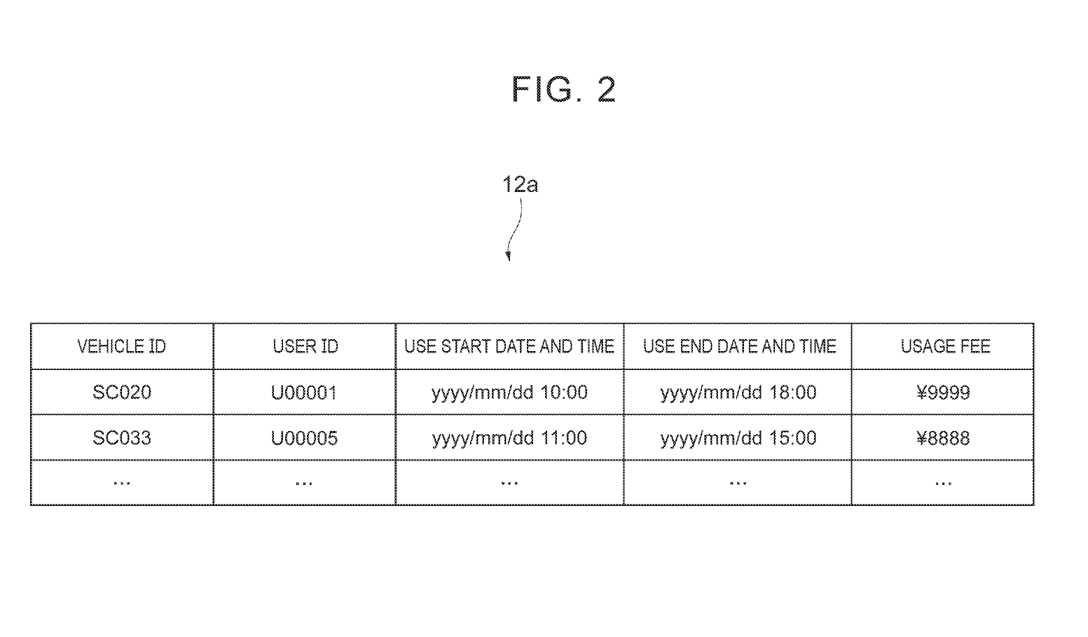

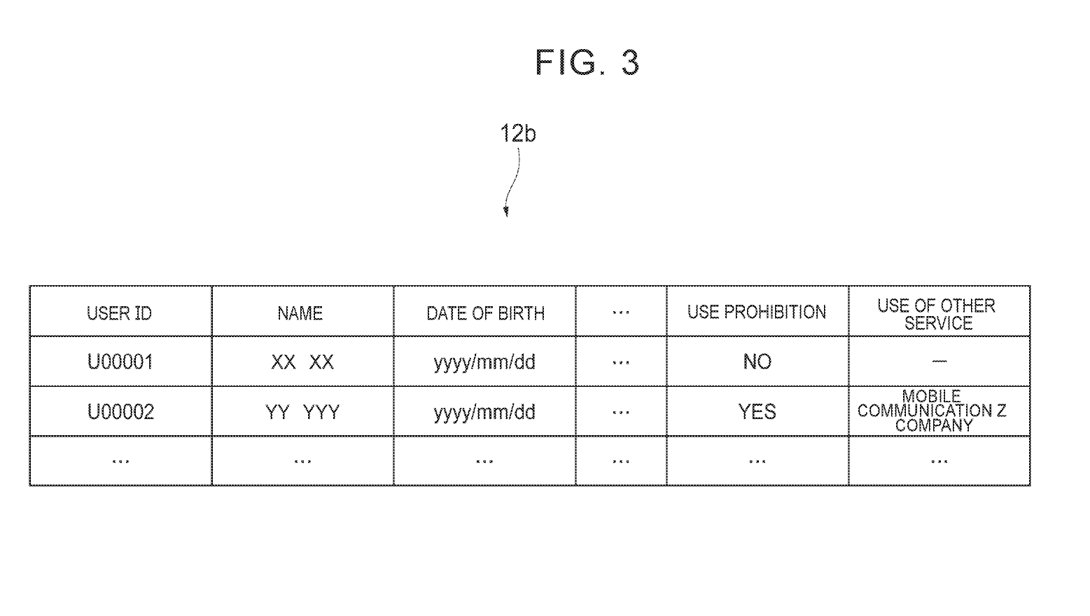

FIGS. 1 to 5 are diagrams for showing a car sharing settlement method and a car sharing management system according to the embodiment. First, the schematic configuration of the car sharing management system according to the embodiment will be described with reference to FIGS. 1 to 3. FIG. 1 is a configuration diagram showing one example of the schematic configuration of a car sharing management system 100 according to the embodiment. FIG. 2 is a data structure diagram showing one example of a car sharing reservation file 12a shown in FIG. 1. FIG. 3 is a data structure diagram showing one example of a user table 12b shown in FIG. 1.

As shown in FIG. 1, the car sharing management system 100 includes a car sharing management device 10 and an IC reader-writer 50.

The car sharing management device 10 manages the car sharing service in which a vehicle SC is used by a plurality of users. The car sharing management device 10 includes, for example, a communication unit 11, a storage unit 12, and a control unit 13. The car sharing management device 10 further includes a bus 14 configured to transmit signals and data between the respective units of the car sharing management device 10.

The communication unit 11 is configured to be communicable with other devices via a communication network N1. For example, the communication unit 11 communicates with a communication device CE included in the vehicle SC via the communication network N1. Further, other-service management devices MA each being a device for a business company of a service other than the car sharing service, such as a mobile communication service or an electricity (electric power) supply service, to manage its own service are communicably connected to the communication network N1.

The storage unit 12 is configured to store programs, data, and so on. The storage unit 12 stores in advance various programs to be executed by the control unit 13, data necessary for execution of the programs, and so on.

Herein, in order to identify users of the car sharing service, unique user IDs are respectively assigned to all users who use the car sharing service. Likewise, with respect to vehicles SC of car sharing, unique vehicle IDs are respectively assigned to all vehicles SC that are used in the car sharing service.

The storage unit 12 further stores in advance the car sharing reservation file 12a. The car sharing reservation file 12a is a file for recording reservation contents of car sharing by users.

As shown in FIG. 2, the car sharing reservation file 12a is, for example, a collection of a plurality of reservation data by collectively treating vehicle ID, user ID, use start date and time, use end date and time, and usage fee as one reservation data. Each reservation data is produced and added to the car sharing reservation file 12a when a user makes a reservation to use the car sharing service.

The storage unit 12 further stores in advance the user table 12b. The user table 12b is a table for managing information about users of car sharing.

As shown in FIG. 3, for example, basic information such as user ID, name, and date of birth, and in addition, information such as use prohibition and use of other service are stored as one record in the user table 12b. To give an example, when use prohibition is “YES”, a user of the subject user ID is not allowed to produce reservation data so that the use of car sharing is prohibited. When data is stored in the column (attribute) of use of other service, this indicates that the car sharing management device 10 can perform data communication with a management device of the stored service. For example, when use of other service is “mobile communication Z company”, the car sharing management device 10 can exchange (transmit and receive) data with a management device of the Z company that provides a mobile communication service.

Referring back to FIG. 1, the control unit 13 is configured to control the operations of the respective units of the car sharing management device 10, such as the communication unit 11 and the storage unit 12. The control unit 13 can be configured by including, for example, a processor such as a central processing unit (CPU), memories such as a read-only memory (ROM), a random-access memory (RAM), and a buffer memory, and so on.

The IC reader-writer 50 is installed in the vehicle SC of car sharing. The vehicle SC includes, in addition to the IC reader-writer 50, for example, the communication device CE and a navigation device NA.

The IC reader-writer 50 is disposed in the vehicle SC, for example, around a seat. The IC reader-writer 50 includes, for example, a short-range communication unit 51, a communication unit 52, a storage unit 53, an operation unit 54, a display unit 55, and a control unit 56. The IC reader-writer 50 further includes a bus 57 configured to transmit signals and data between the respective units of the IC reader-writer 50.

The short-range communication unit 51 performs wireless communication with an IC card CA. An IC chip is installed in the IC card CA, and prepaid electronic money is stored in the IC chip. The short-range communication unit 51 is configured to be communicable with the IC card CA to read and write the electronic money of the IC chip when the IC card CA is brought in close vicinity to the short-range communication unit 51. The short-range communication unit 51 corresponds to one example of “a reading unit” of the disclosure.

The short-range communication unit 51 is configured to be able to read and write a plurality of kinds of prepaid electronic money. The short-range communication unit 51 can be configured by including, for example, a near field communication (NFC) chip. In this case, the short-range communication unit 51 can read and write electronic money of an IC chip regardless of its kind as long as the IC chip conforms to the NFC standard.

The IC card CA is only one example, and the form is not limited to a card as long as it includes an IC chip storing prepaid electronic money. For example, it may be in the form of a keychain, a wristband, an information terminal cover, or the like including an IC chip.

The communication unit 52 is connected to the communication device CE of the vehicle SC. The communication unit 52 is configured to be communicable with the car sharing management device 10 via the communication device CE and the communication network N1.

The storage unit 53 is configured to store programs, data, and so on. The storage unit 53 stores in advance various programs to be executed by the control unit 56, data necessary for execution of the programs, and so on. Further, the storage unit 53 stores in advance a vehicle ID of the subject vehicle SC in which the IC reader-writer 50 is installed.

The operation unit 54 is configured to allow a user to input information by a user's operation. The operation unit 54 can be configured by including, for example, a touch panel, buttons, a keypad, or the like. In the case of this example, when the user operates the touch panel, the buttons, the keypad, or the like, for example, the control unit 56 produces data corresponding to an operation so that it is possible to input information into the IC reader-writer 50.

The display unit 55 is configured to output information. The display unit 55 can be configured by including, for example, a display device such as a liquid-crystal display, an electroluminescent (EL) display, or a plasma display. In the case of this example, the display unit 55 can output information by displaying data on the display device.

The control unit 56 is configured to control the operations of the respective units of the IC reader-writer 50, such as the short-range communication unit 51, the communication unit 52, the storage unit 53, the operation unit 54, and the display unit 55. The control unit 56 can be configured by including, for example, a processor such as a CPU, memories such as a ROM, a RAM, and a buffer memory, and so on. The control unit 56 includes, as its functional configurations, for example, an acquisition unit 56a, a subtraction unit 56b, a notification unit 56c, and a collection unit 56d.

When the short-range communication unit 51 has read the balance of the electronic money of the IC card CA, the acquisition unit 56a acquires a usage fee from the car sharing management device 10. Specifically, the acquisition unit 56a produces a usage fee request including the vehicle ID stored in the storage unit 53 and transmits, using the communication unit 52, the usage fee request to the car sharing management device 10 via the communication device CE and the communication network N1. The car sharing management device 10 reads, based on the received vehicle ID, corresponding reservation data from the car sharing reservation file 12a stored in the storage unit 12 and transmits the read reservation data to the IC reader-writer 50 via the communication network N1 and the communication device CE. In this way, the reservation data including a usage fee of the vehicle SC is acquired.

The subtraction unit 56b is configured to subtract a prescribed amount from the electronic money of the IC card CA based on the balance and the usage fee. For example, when the balance is equal to or greater than the usage fee, the subtraction unit 56b subtracts the usage fee from the electronic money and writes it into the IC card CA using the short-range communication unit 51. On the other hand, when the balance is less than the usage fee, the subtraction unit 56b subtracts the balance from the electronic money and writes it into the IC card CA using the short-range communication unit 51. Settlement data of the amount subtracted from the electronic money of the IC card CA is transmitted from the communication unit 52 to the car sharing management device 10 via the communication device CE and the communication network N1. The car sharing management device 10 stores the received settlement data into the storage unit 12 and transmits it as settlement data to an electronic money management server (not shown) via the communication unit 11 and the communication network N1.

In this embodiment, the example is shown where when the balance of the electronic money is less than the usage fee, the subtraction unit 56b subtracts the full balance from the electronic money, but not limited thereto. For example, the subtraction unit 56b may subtract an amount less than the balance from the electronic money. In this case, the prescribed amount that the subtraction unit 56b subtracts from the electronic money may be set to “zero”. That is, the subtraction unit 56b may be configured not to subtract from the electronic money.

The notification unit 56c is configured to notify the user of car sharing of a place where payment to the electronic money of the IC card CA is enabled. For example, the notification unit 56c produces a payment place request including the vehicle ID stored in the storage unit 53 and the kind information of the electronic money read from the IC card CA and transmits, using the communication unit 52, the payment place request to the car sharing management device 10 via the communication device CE and the communication network N1. Based on the vehicle ID and the kind information of the electronic money, the car sharing management device 10 transmits information about a place, where payment to the subject electronic money is enabled, to the IC reader-writer 50 via the communication network N1 and the communication device CE. The information about the place where payment to the electronic money is enabled may be stored in the storage unit 12 or may be acquired by the car sharing management device 10 from another server or the like via the communication network N1. Then, the notification unit 56c outputs the received information about the place, where payment to the electronic money is enabled, to the display unit 55 so that the information is displayed on the display unit 55. In this way, the place where payment to the electronic money is enabled is notified to the user. The information about the place where payment to the electronic money is enabled may be information around a renting place of the vehicle SC, a return place of the vehicle SC, or a current location.

In this embodiment, the example is shown where the notification unit 56c causes the display unit 55 to display the information about the place where payment to the electronic money is enabled, but not limited thereto. For example, the notification unit 56c may cause a display unit (not shown) of the navigation device NA to display the information about the place where payment to the electronic money is enabled. Alternatively, the notification unit 56c may transmit the information about the place, where payment to the electronic money is enabled, to an information terminal (not shown) of the user. Alternatively, the car sharing management device 10 having received the payment place request may transmit the information about the place, where payment to the electronic money is enabled, to an information terminal (not shown), such as a mobile phone, a smartphone, or a tablet, possessed by the user so as to cause the user's information terminal to display the information.

The collection unit 56d is configured to collect the difference between the usage fee and the prescribed amount during use or after use of the vehicle SC. In the case where the subtraction unit 56b subtracts the balance as the prescribed amount as described above, the collection unit 56d collects the difference between the usage fee and the balance. In the case where the subtraction unit 56b does not subtract the prescribed amount, the collection unit 56d collects the full amount of the usage fee. Settlement data of the difference or the full amount collected from the electronic money of the IC card CA is transmitted from the communication unit 52 to the car sharing management device 10 via the communication device CE and the communication network N1. The car sharing management device 10 stores the received settlement data into the storage unit 12 and transmits it as settlement data to the electronic money management server via the communication unit 11 and the communication network N1.

The collection unit 56d is configured to prohibit the use of car sharing by the user. For example, the collection unit 56d produces a use prohibition request including a user ID of reservation data acquired by the acquisition unit 56a and transmits the use prohibition request to the car sharing management device 10 via the communication device CE and the communication network N1. Based on the received use prohibition request, the car sharing management device 10, for example, changes and updates the column of use prohibition, shown in FIG. 3, to “YES” for the corresponding user ID of the user table 12b stored in the storage unit 12. In this way, the use of car sharing by the subject user is prohibited.

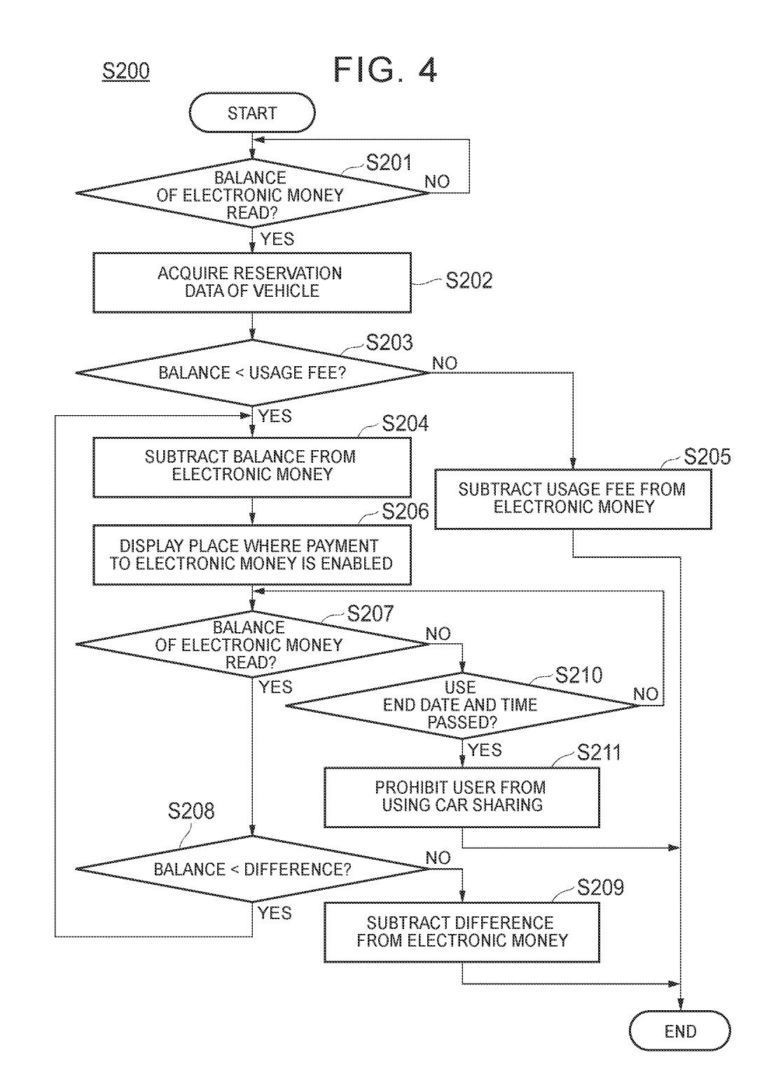

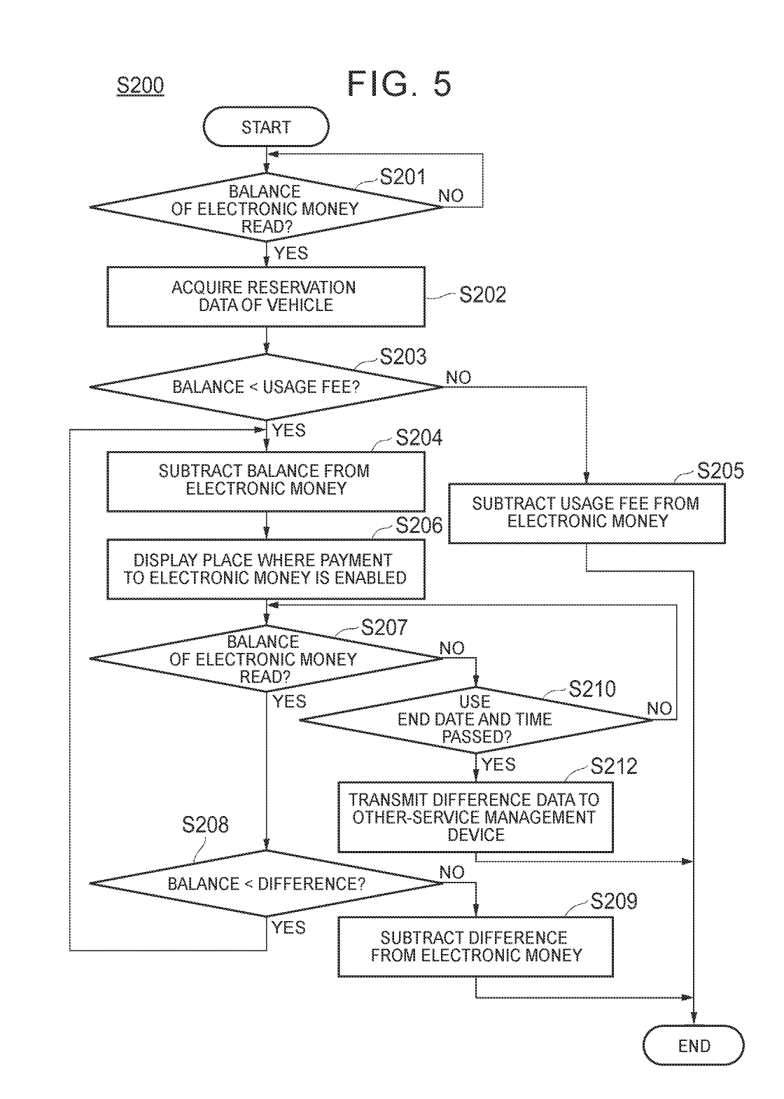

Next, referring to FIGS. 4 and 5, the general operation of the car sharing management system 100 will be described. FIG. 4 is a flowchart for explaining one example of the operation of the car sharing management system 100 shown in FIG. 1. FIG. 5 is a flowchart for explaining another example of the operation of the car sharing management system 100 shown in FIG. 1.

For example, when a user of the car sharing management system 100 uses the vehicle SC, and more specifically, when the vehicle SC is turned on, the car sharing management system 100 performs settlement processing S200 shown in FIG. 4.

First, the short-range communication unit 51 of the IC reader-writer 50 determines whether or not an IC card CA is brought in close vicinity to the short-range communication unit 51 so that the short-range communication unit 51 has read the balance of electronic money of the IC card CA (S201). The short-range communication unit 51 repeats the process of step S201 until the short-range communication unit 51 has read the balance of the electronic money of the IC card CA brought in close vicinity thereto.

When the short-range communication unit 51 has read the balance of the electronic money of the IC card CA as a result of the determination at step S201, the acquisition unit 56a acquires reservation data of the subject vehicle SC from the car sharing reservation file 12a stored in the storage unit 12 of the car sharing management device 10 (S202).

Then, the subtraction unit 56b determines whether or not the balance of the electronic money read at step S201 is less than a usage fee included in the reservation data acquired at step S202 (S203).

When the balance of the electronic money is less than the usage fee as a result of the determination at step S203, the subtraction unit 56b subtracts the balance from the electronic money (S204). In this event, the subtraction unit 56b calculates the difference between the usage fee and the balance and stores it in the memory or the like. Further, as described above, the short-range communication unit 51 writes the subtraction into an IC chip of the IC card CA.

On the other hand, when the balance of the electronic money is not less than the usage fee, i.e. when the balance of the electronic money is equal to or greater than the usage fee, as a result of the determination at step S203, the subtraction unit 56b subtracts the usage fee from the electronic money (S205). In this event, likewise, the short-range communication unit 51 writes the subtraction into the IC chip of the IC card CA.

At step S205, the subtraction unit 56b subtracts the usage fee from the electronic money so that the usage fee of the vehicle SC of car sharing is settled. Therefore, after step S205, the car sharing management system 100 ends the settlement processing S200.

After step S204, the notification unit 56c causes the display unit 55 to display information about a place where payment to the electronic money of the IC card CA is enabled (S206). This enhances the probability of payment to the electronic money of the IC card CA.

Then, the short-range communication unit 51 determines whether or not the IC card CA is brought in close vicinity to the short-range communication unit 51 so that the short-range communication unit 51 has read the balance of the electronic money of the IC card CA (S207).

When the short-range communication unit 51 has read the balance of the electronic money of the IC card CA as a result of the determination at step S207, the collection unit 56d determines whether or not the balance of the electronic money read at step S207 is less than the difference calculated at step S204 (S208).

When the balance of the electronic money is less than the difference as a result of the determination at step S208, the processing returns to step S204 so that the subtraction unit 56b subtracts the balance from the electronic money. In this event, the subtraction unit 56b calculates the difference between the difference and the balance and stores it in the memory or the like. That is, the subtraction unit 56b updates the difference. Further, the short-range communication unit 51 writes the subtraction into the IC card CA.

Thereafter, the car sharing management system 100 performs step S206 and subsequent steps again.

On the other hand, when the balance of the electronic money is not less than the difference, i.e. when the balance of the electronic money is equal to or greater than the difference, as a result of the determination at step S208, the collection unit 56d subtracts the difference from the electronic money (S209). In this event, likewise, the short-range communication unit 51 writes the subtraction into the IC card CA.

At step S209, the collection unit 56d subtracts the difference from the electronic money so that the usage fee of the vehicle SC of car sharing is settled. Therefore, after step S209, the car sharing management system 100 ends the settlement processing S200.

On the other hand, when the short-range communication unit 51 has not read the balance of the electronic money of the IC card CA as a result of the determination at step S207, the collection unit 56d determines, using a time watch function of the control unit 56, whether or not a use end date and time included in the reservation data acquired at step S202 has passed (S210).

When the use end date and time has passed as a result of the determination at step S210, it is considered that the use of car sharing by a user has ended. However, the difference calculated or updated at step S204 has still not been collected. Therefore, the control unit 13 of the car sharing management device 10 prohibits a user of a user ID included in the reservation data acquired at step S202 from using car sharing (S211).

After step S211, the car sharing management system 100 ends the settlement processing S200.

On the other hand, when the use end date and time has not passed as a result of the determination at step S210, the processing returns to step S207 where the short-range communication unit 51 again determines whether or not the IC card CA is brought in close vicinity to the short-range communication unit 51 so that the short-range communication unit 51 has read the balance of the electronic money of the IC card CA.

In FIG. 4, the example is shown where when the use end date and time has passed as a result of the determination at step S210, the control unit 13 of the car sharing management device 10 prohibits a user of a user ID included in the reservation data from using car sharing at step S211, but not limited thereto.

For example, as shown in FIG. 5, when the use end date and time has passed as a result of the determination at step S210, the difference calculated or updated at step S204 has still not been collected as described above. In the case of this example, the collection unit 56d produces difference data including the user ID of the reservation data acquired at step S202 and the difference calculated or updated at step S204 and transmits the difference data to the car sharing management device 10 via the communication device CE and the communication network N1, and the control unit 13 of the car sharing management device 10 refers to the user table 12b stored in the storage unit 12 to search for another service used by the subject user and transmits the difference data to the corresponding other-service management device MA via the communication unit 11 and the communication network N1 (S212). The other-service management device MA, for example, adds the difference of the received difference data to a usage fee of its own service and charges the total amount to the subject user for collection.

Since steps other than step S212 in the settlement processing S200 shown in FIG. 5 are the same as those in the settlement processing S200 shown in FIG. 4, a description of these steps is omitted.

As described above, according to the car sharing settlement method and the car sharing management system of this embodiment, there are included a step of, when a user uses the vehicle SC of car sharing, reading the balance of prepaid electronic money stored in an IC card CA of the user using the IC reader-writer 50, a step of acquiring a usage fee of the vehicle SC by the user from the car sharing management device 10, a step of, when the balance is less than the usage fee, subtracting a prescribed amount equal to or less than the balance from the electronic money of the IC card CA using the IC reader-writer 50, and a step of collecting the difference between the usage fee and the prescribed amount during use or after use of the vehicle SC by the user. Consequently, since the difference is collected during use or after use of the vehicle SC, even when the balance of the electronic money is insufficient when using the vehicle SC, the shortfall can be collected ex post facto. Therefore, even when the balance of the prepaid electronic money is insufficient, the usage fee can be paid and the payment by the prepaid electronic money is enabled, so that the use of car sharing can be promoted.

The embodiments described above are only for facilitating understanding of the disclosure, and not for interpreting the disclosure as being limited thereto. The elements included in the embodiments, and the arrangement, materials, conditions, shapes, sizes, and so on of the elements are not limited to those shown above and can be changed as appropriate. Further, it is possible to partially replace or combine the configurations shown in the different embodiments.

What is claimed is:

1. A car sharing settlement method comprising:
when a user uses a vehicle of car sharing, reading a balance of electronic money stored in an IC chip of the user using an IC reader-writer, the electronic money being prepaid;
acquiring a usage fee of the vehicle by the user from a car sharing management device;
when the balance is less than the usage fee, subtracting a prescribed amount equal to or less than the balance from the electronic money of the IC chip using the IC reader-writer; and
collecting a difference between the usage fee and the prescribed amount during use or after use of the vehicle by the user.

2. The car sharing settlement method according to claim 1, wherein collecting the difference includes subtracting the difference from the electronic money of the IC chip using the IC reader-writer, the electronic money having received payment.

3. The car sharing settlement method according to claim 2, wherein collecting the difference includes notifying the user of a place where payment to the electronic money of the IC chip is enabled.

4. The car sharing settlement method according to claim 1, further comprising causing the car sharing management device to prohibit use of the car sharing by the user after use of the vehicle until the difference is collected.

5. The car sharing settlement method according to claim 1, wherein collecting the difference includes collecting the difference by a management device of another service that is used by the user.

6. A car sharing management system comprising:
an IC reader-writer; and
a car sharing management device,
wherein the IC reader-writer includes: a reading unit configured to, when a user uses a vehicle of car sharing, read a balance of electronic money stored in an IC chip of the user, the electronic money being prepaid; an acquisition unit configured to acquire a usage fee of the vehicle by the user from the car sharing management device; a subtraction unit configured to, when the balance is less than the usage fee, subtract a prescribed amount equal to or less than the balance from the electronic money of the IC chip; and a collection unit configured to collect a difference between the usage fee and the prescribed amount during use or after use of the vehicle by the user.
